(19) United States
(12) Patent Application Publication
(10) Pub. No.: US 2025/0007733 A1
(43) Pub. Date: Jan. 2, 2025

(54) METHOD FOR SECURE COMMUNICATION VIA THE INTERNET

(71) Applicants: Michael Rolf, Lachen (CH); Martin Trutt, Leipzig (DE)

(72) Inventors: Michael Rolf, Lachen (CH); Martin Trutt, Leipzig (DE)

(21) Appl. No.: 18/827,919

(22) Filed: Sep. 9, 2024

Related U.S. Application Data
(63) Continuation-in-part of application No. PCT/EP2023/051989, filed on Jan. 27, 2023.

(30) Foreign Application Priority Data
Mar. 10, 2022 (EP) 22161405.0

(51) Int. Cl. H04L 9/32; G06F 21/60

(52) U.S. Cl. CPC H04L 9/3263; G06F 21/606

(57) ABSTRACT

A computer-implemented method for information-secure communication between at least a first communication partner and a second communication partner is provided with the first communication partner has a first communication device, and the second communication partner has a second communication device. The method includes installing a computer program product on a computing unit of the first communication device and on a computer unit of the second communication device, wherein the computer program product. An invitation is transmitted from the first communication device to the second communication device, wherein a security certificate is transmitted to the second communication device upon transmission of the invitation. The invitation is accepted by the second communication device and verifying the security certificate. An intermediate server is fed back when the test of the security certificate has passed. The communication is directly transmitted between the devices.

### RELATED APPLICATIONS

This application is a continuation-in-part of PCT/EP2023/051989, filed Jan. 27, 2023, that in turn claims priority benefit of EP 22161405.0, filed Mar. 10, 2022; the contents of which are hereby incorporated by reference.

### FIELD OF THE INVENTION

In one aspect, the invention addresses a method for certificate-supported, anonymous and tap-proof communication.

Furthermore, the invention relates to a computer-implemented method for information-secure communication between at least a first communication partner and a second communication partner, wherein the first communication partner has a first communication device, and the second communication partner has a second communication device, comprising the following steps:
a) installing a computer program product on a computing unit of the first communication device and the second communication device,
b) transmitting an invitation from the first communication device to the second communication device, wherein a security certificate is transmitted to the second communication device upon transmission of the invitation,
c) accepting the invitation by the second communication device and verifying the security certificate,
d) feeding back to an intermediate server when the test of the security certificate has passed,
e) directly transmitting communication data between the first communication device and the second communication device.

Furthermore, the invention addresses both a communication device network and a computer program product.

### BACKGROUND AND PRIOR ART

Current communication mainly takes place via the Internet. For example, estimated billions of people use WhatsApp to send messages. But other services, such as social media platforms (e.g. Instagram, Facebook, etc.), are also used for communication. Furthermore, platforms that combine chats, meetings, notes and attachments, such as Microsoft Teams or Zoom, have also become increasingly important. Such services have become a focus of many people, especially in the wake of the Covid-19 pandemic, when it was initially undesirable and sometimes even impossible for people to have frequent and close contact with each other. In an age of modernization and globalization, software platforms for communication are becoming increasingly relevant.

Most software systems that are currently in use are based on so-called client-server solutions so that the operator of the software always has data sovereignty (see also FIG. 1). The user of the software cannot understand in detail what the manufacturer does with the data that are distributed via its server. This problem applies both to software for email traffic as well as to chats, social media accounts and/or video conferences.

Furthermore, there are risks regarding data security when users use the software-based communication options mentioned above. The functionalities of the software used in each case also offer the possibility of misuse by the users themselves since they have the option to automatically generate topics, comments and/or responses. The current systems therefore manifest security-related weaknesses, both on the part of the software providers (hosts) and on the part of the users of the individual software packages. In addition to the mentioned software platforms, these disadvantages also exist in systems such as Telegram, iMessage and/or other comparable software.

With the introduction of the GDPR (General Data Protection Regulation), various efforts have been made to protect the data generated during communication over the Internet. Although corporations such as Facebook are faced with ever-increasing regulations, real control over data flows or the way in which they are handled is however not possible. One of the reasons for this is that the data generated and collected can easily be processed across national borders, meaning that national laws often cannot be enforced.

Chat users, users of conference software and/or users of social media software cannot determine whether sent messages were created by humans, software and/or a robot. With the current means of the state-of-the-art, there is no way for users who use the communication possibilities of the modern Internet to know who really generated the data. It is also not clear what is done with the data you generate/send.

In particular, given the current state of the art, it is not possible to clearly identify a user with whom one communicates via email or chat. Anyone can create a user account with any identifier and communicate through it. Fictitious communication can also be set up through identity theft. Given the current state of the art, this is a common method of obtaining information or money. The current state of the art makes it possible to communicate using false identities or to flood platforms with messages from automated systems without people being able to recognize that you are communicating with machines, and not with people. According to the current state of the art, it is relatively easy to modify messages after sending so that the recipient receives a message with changed content. To undertake measures against this type of attack, additional encryption systems must be installed in today's systems.

US 2013/0036308 A1 and [1] describe how communication over the Internet is established via SIP (Session Initiation Protocol) protocols. Both disclosures discuss working with an SIP proxy through which data traffic is authorized and routed. The certification of the variant described in US 2013/0036308 A1 is based on a SMIME (Secure/Multipurpose Internet Mail Extensions) standard-based certificate which is used to identify the user and to encrypt the connection. Furthermore, the SIP protocol aims to connect individual users to each other as flexibly as possible. This also includes the possibility for each user to be able to contact another user. The connection itself can also be secured by encryption.

[2] is essentially aimed at connecting users of 5G networks to each other as securely and flexibly as possible. This means that the functionalities of all programs include the use of 5G (or other standards) through which communication or data exchange can take place. The SIP protocol then uses this transmission technology disclosed in [2] to enable connections to other users. This technology also aims to enable as many users as possible to interact with each other as easily as possible.

However, these methods require an application server to establish the connection, which server provides the corresponding protocols (e.g. SIP) and services. Since mass communication is the central focus of this technology, considerable resources must be allocated.

However, this orientation also requires that, in principle, every user can contact another user, even without the two users knowing each other or having agreed to the communication in advance.

Since the known technologies require considerable resources, these resources are used by a plurality of service providers. Microsoft, for example, is not building its own 5G networks, but uses those of others and relies on standards such as SIP protocols to establish communication. Said standards always work according to the same rules/measures and safety standards. This can ensure that this communication works across the boundaries of individual service providers.

For example, a Telekom user can communicate with an O2 user (FIG. 15). A major disadvantage, however, is that all communication must be processed using technology from a wide range of providers. The measure of maximum security therefore always lies with the service providers who provide the corresponding services. It can also never really be guaranteed that the service providers will not use the resulting data for their own purposes.

There is therefore a need to make communication options using the Internet more secure.

### OBJECT OF THE INVENTION

The object of the present invention was to eliminate the disadvantages of the prior art. In particular, it was an object of the invention to provide a communication option that reliably protects improved data security and communication as such against attacks.

### SUMMARY OF THE INVENTION

The object according to the invention is achieved by the features of the independent claims. Advantageous embodiments of the invention are described in the dependent claims.

In a first aspect, the invention relates to a method for certificate-supported, anonymous and tap-proof communication.

The invention also relates to a method for certificate-based connection control.

Furthermore, the invention addresses a method for certificate-supported direct communication between PCs and cluster-supported load distribution of the individual PCs involved in the communication.

Another aspect of the invention is a method for intermediate servers and applications for registration and certificate-based invitation of additional anonymous users.

The invention also relates to a method for load distribution in direct PC-supported communication.

Furthermore, the invention addresses a method for load distribution in direct PC-supported communication with integrated legally secure communication security for companies.

In addition, the invention relates to a software-supported method for controlling and certificate-supported, anonymous, serverless communication between clients.

The invention also relates to a method for a certificate-supported communication server for registration and anonymous establishment of contact.

Furthermore, the invention addresses a method for a certificate-supported communication server for registration, contact establishment and legally secure storage for companies.

In a further aspect, the invention relates to a computer-implemented method for information-secure communication between at least a first communication partner and a second communication partner, wherein the first communication partner has a first communication device, and the second communication partner has a second communication device, comprising the following steps:
a) installing a computer program product on a computing unit of the first communication device and the second communication device,
b) transmitting an invitation from the first communication device to the second communication device, wherein a security certificate is transmitted to the second communication device upon transmission of the invitation,
c) accepting the invitation by the second communication device and verifying the security certificate,
d) feeding back to an intermediate server when the test of the security certificate has passed,
e) directly transmitting communication data between the first communication device and the second communication device.

### BRIEF DESCRIPTION OF THE FIGURES

FIG. 1 Schematic representation of a communication method from the prior art;

FIG. 2 Schematic representation of a preferred method of encrypted communication;

FIG. 3 Schematic representation of a data exchange between an intermediate server and a communication device;

FIG. 4 Schematic illustration of certificate-based communication;

FIG. 5 Schematic representation of certificate-based connection controlling;

FIG. 6 Schematic representation of an intermediate server not present;

FIG. 7 Illustration of client behavior when the intermediate server is no longer accessible;

FIG. 8 Method for the intermediate server or an application for registration and certificate-based invitation of additional anonymous users;

FIG. 9 Schematic representation of a method for load distribution;

FIG. 10 Representation of a load distribution by an inviting communication device;

FIG. 11 Representation of a load distribution by an inviting communication device and an exchange;

FIG. 12 Illustration of serverless communication between clients;

FIG. 13 Representation of an intermediate server;

FIG. 14 Illustration of an exchange;

FIG. 15 Schematic representation of a communication method from the prior art;

FIG. 16 Schematic representation of a preferred IP-based communication;

FIG. 17 Schematic representation of a preferred approval method;

FIG. 18 Schematic representation of an initial certificate;

FIG. 19 Schematic representation of a release certificate; and

FIG. 20 Schematic representation of a communication certificate.

### DETAILED DESCRIPTION OF THE INVENTION

With the aid of the preferred method, in particular the computer program product (also referred to as Point One or Point One App in the context of the invention), the weaknesses existing in the prior art during communication using the Internet are advantageously eliminated. Fake identities, identity theft, automated mass messages with opinionated content or changes to sent messages are advantageously no longer possible.

Advantageously, the computer program product and/or the preferred method preferably only allows communication between people who have clearly identified themselves. Automated mass messages are not possible because the computer program product (Point One) is a self-contained system that does not support the possibility of connecting to third-party software.

In particular, the function of the computer program product (Point One or Point One App) is based on the creation of the security certificates and the encryption and connection data contained therein. Only users who have been clearly identified can communicate. By registering as a user (synonym for communication partner) on the (Point One App) intermediate server, the user receives a unique identifier and a certificate with which the software can be installed once. Preferably, the user can only establish a connection with other registered users of the Point One app or the computer program product if he has been invited by the latter, or if he has previously invited the user. Preferably, after an invitation has been accepted, the computer program products exchange connection data, such as IP addresses, at regular intervals in order to be reachable by each other. Preferably, any form of transmission is encrypted and goes directly from communication device to communication device (e.g. a PC). Preferably, servers are not involved in the communication. For the encryption, security certificates are preferably used that were previously exchanged and approved during the invitation. This makes it impossible for potential attackers to listen in on or influence the communication.

In the following, examples of (but not limited to) communication methods and different types of communication data exchange are illustrated:

### Example of Connection Establishment—Text Message:

A user of the computer program product (Point One App) sends a message to another user of the computer program product. The port on which the message arrives is monitored by the computer program product. When a data packet arrives on the monitored port, it is checked whether it uses an approved identifier and the appropriate encryption. Only when this is the case will the data packet be processed by the computer program product. Data packets that do not meet the requirements regarding the identifier or encryption are blocked. Data packets that meet the requirements of the computer program product are processed.

### Example of Connection Establishment—Video Message:

Here too, the incoming data packets are checked first, and only approved data packets are processed. If the data packets are accepted, a two-way connection is established. This is done via the connection information that is exchanged between the users. The data that are transmitted during the connection are encrypted before being sent and can only be decrypted by the recipient, since only he has the corresponding key.

The actual process of image and/or sound recording or text creation is preferably carried out using the current methods of the state of the art. The differences compared to the state of the art lie primarily in the fact that communication only takes place with a unique identifier, only with the received certificate, only encrypted, and only between the involved communication devices. The data that are generated during communication are only decrypted and stored on the involved systems.

The combination of the proposed method steps leads to a surprising synergy effect, which results in the advantageous properties and the associated overall success of the invention. The individual features and/or method steps of the invention interact with one another.

A particularly significant advantage of the preferred method is that serverless transmission of communication data is enabled. However, according to the current state of the art, the communication data would be routed via the server of the software provider. In the preferred method, the intermediate server is advantageously the point at which the information for establishing the connection of the communication devices is set up. This can advantageously prevent data, in particular communication data, from being delivered via a server of the server provider. Consequently, the preferred method advantageously significantly increases data security as such for communication. This also means that direct communication, i.e. avoiding a “detour” to a server, between communication device and communication device, can also be regarded as a departure from the status quo.

By using the preferred method, communication partners can advantageously communicate with each other securely against eavesdropping and directly. Only by tracing the accessed IP addresses could it be determined whether communication devices were in a data connection with each other.

The preferred steps of the preferred method can be carried out in particular by the embodiment of the computer program product.

Preferably, communication between communication partners is only possible if all communication partners have installed the computer program product on a computing unit of the given communication device. This means that communication is restricted to the circle of people who have installed the preferred computer program product. Advantageously, unwanted contact, for example in contrast to telephone calls and/or SMS messages, is not possible via the preferred computer program product. Thus, the preferred method advantageously increases security-relevant aspects for data exchange between people.

Since communication, in particular communication via the Internet, takes place using communication devices, the technical character of the preferred method is given. This advantageously prevents third parties from disrupting communication, accessing communication data and/or changing these data.

The preferred communication between a first and a second communication partner is not limited to just two communication partners. This means that 3, 4, 5, 6, 7, 8, 9, 10, 50, 100, 1000 or more communication partners can also communicate with each other.

In particular, the following requirements are necessary for communication to take place:

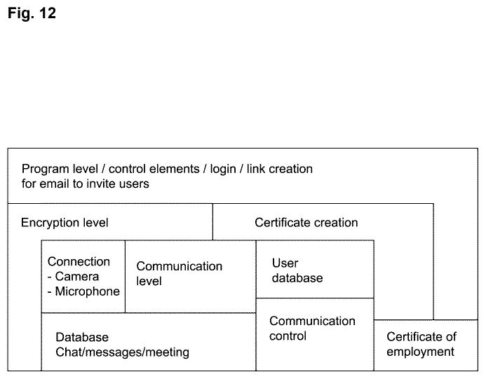

1. The communication devices of the communication participants must each have the computer program product available (see FIG. 12).
2. A communication participant must send an invitation, which in turn must be accepted.
3. An invitation can only be sent by a communication participant who owns a computer program product (the Point One app) that has this function. A communication participant who owns a computer program product that can only accept invitations (the Point Zero app) accordingly cannot send invitations. Such a communication participant cannot plan meetings either; he can only establish ad hoc connections with users from whom he has been invited.

Preferably, when an invitation is transmitted from the first communication device to the second communication device, a security certificate is also transmitted to the second communication device.

Preferably, a user identifier of the first communication device is checked with the security certificate of the second communication device. The certificates of the first communication device (inviter) and the second communication device (invitee) must each have the appropriate user identifier so that the connection information can be exchanged. Without this initial synchronization, the communication devices, and therefore the communication participants, cannot communicate with each other.

After the verification of the certificates, the connection of the security certificates of the given communication participants is preferentially enabled. For this purpose, the part of the security certificate that manages the invited communication participants is used, and in certificate management, the security certificate of the inviter is provided with an addendum, thus confirming the accepting the invitation. Directly afterward, this security certificate is sent to the inviter. If the inviter now confirms this on his communication device, the certificate within the computer program product is expanded to include the information of the invitee. From this point on, the first communication partner (inviter) and the second communication partner (invitee) can communicate with each other via the computer program product.

The communication takes place directly between each other, i.e. without a “detour” to reach the server of a software provider. In terms of the invention, “direct communication” refers in particular to a serverless transmission of communication data. In particular, direct communication means that there is no server that establishes the communication, buffers and/or distributes the communication data. The data are preferably transmitted directly from one communication device to the other communication device via the Internet. The Internet servers that preferably transmit data cannot see what you are transmitting; they preferably simply forward the data packets.

The intermediate server in this case cannot be compared with a standard server of a standard state-of-the-art current server provider for communications software. Preferably, the intermediate server is an intermediary that does not store any data other than the security certificate. According to the current state of the art, communication would be routed via the server of the software provider. However, according to the invention, the intermediate server is merely the point that makes the information for establishing the connection available to the authorized users.

In terms of the invention, information-secure communication refers to communication such that no information is processed, saved and/or stored, so that protection objectives such as confidentiality, availability and/or integrity are realized. In particular, information-secure communication serves to protect against dangers and threats and to minimize risks with regard to the sovereignty of information that is provided during communication via the Internet.

A communication device preferably refers to a device with which communication can be carried out, in particular using the Internet. Thus, in the context according to the invention, a communication device can be a computer, a tablet, an iPad, a smartphone, and/or a similar device.

Preferably, a communication device has a communication unit in order to be able to carry out the communication as such. The communication unit refers to a transmitting and/or receiving unit that is configured to send and/or receive data.

The computing unit preferably refers to any device that can be configured to perform computing operations. Preferably, the computing unit is a processor, a processor chip, a microprocessor and/or a microcontroller. The computing unit can also preferably be a programmable circuit board. The computing unit can also preferably comprise a computer-usable or computer-readable medium such as a hard disk, random access memory (RAM), read-only memory (ROM), flash memory, etc.

In a further preferred embodiment, the computer-implemented method is characterized in that the security certificate is provided by the installation of the computer program product.

Preferably, before installing the computer program product on a communications device, the user of the computer program product is registered as a potential communications participant. Registration takes place with the manufacturer of the computer program product. Each user of the computer program product is registered and receives a registration key exclusively tailored for him that can only be used by this user. Preferably, the computer program product can be installed on a maximum of 3 communication devices. For each additional installation, additional registration keys are preferably required.

On the one hand, the registration key enables the installation of the computer program product and, on the other hand, it ensures the synchronization of each of the installed computer program products that are used with the identical registration key and/or whose registration keys belong to a group that can be assigned to the same user. The synchronization of the individual computer program products ensures that an internal database of the computer program product always has the same state of information on all communication devices of a user. The login to receive the registration key is preferably the only moment at which user data are stored.

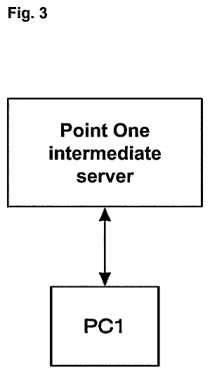

When installing the computer program product, it is preferable that the user contacts the manufacturer to verify the registration key, wherein an Internet connection is preferably required for this. In addition, the number of installations already carried out is preferably verified. Preferably, the installation will only continue if the registration key check was successful, and the maximum number of installations has not yet been reached (see FIG. 3).

When installing the computer program product, various information is requested from the communications device and/or the computing unit on which the software is installed. This information is used, on the one hand, to create a security certificate that is used to subsequently encrypt the communication data and, on the other hand, to ensure that the computer program product can only be installed on the maximum number of devices. Each installation with the unique registration key or one of the associated extended registration keys of the group makes it possible to clearly identify how many communication devices the registration key has already been used on. The particular security certificate created in this way comprises a plurality of parts. One part is preferably published as a public key on the server of the manufacturer.

The public key advantageously does not allow any conclusions to be drawn as to who generated this key. The public key is preferably used by the computer program product to provide the information necessary to establish a connection with the invited users who have authorization for an account. This advantageously makes computer program products accessible to authorized users as soon as they are online, i.e. in particular when the communication devices are connected to the Internet.

The intermediate server is preferably provided for this purpose. In the case of communication between a plurality of communication participants with particular communication devices, in particular in the context of private communication, the intermediate server makes it possible to establish contact between the communication participants. The intermediate server acts as an intermediary and does not store any other data, in particular no communication data, apart from the security certificate.

Preferably, the certificate created during the first installation is also required to install the computer program product a second time on the same communications device. This can advantageously be necessary if the communication device needs to be reset after a problem. The security certificate is also preferably required in order to be able to synchronize the data from other installations after reinstallation.

Advantageously, the security certificate cannot be renewed, which also increases the security of communication. After a one-time creation (per communication device), the computer program product can preferably only be installed on the particular communication device with the associated security certificate. Preferably, if the security certificate is damaged or if it is lost, a new registration key must be created.

Only if the new registration key can preferably be assigned to the same group can the existing installations communicate and synchronize with the newly installed version. In particular, if a new communication device is purchased and an old communication device equipped with the computer program product is decommissioned, a new registration will be required if it was already installed on the maximum number of communication devices.

Preferably, when installing the communications device, a folder is created that the computer program product can access. The computer program product is preferably largely shielded from the operating system. This means that the transfer of data from the computer program product to the communication device can preferably only take place via the folder created by the computer program product. Access via the clipboard or another directory is not possible here. Preferably, however, this folder is not synchronized.

The computer program product preferably has a database in which the communication histories, the contacts approved for communication and the data generated in this process are stored. Preferably, only this database is synchronized. The database is preferably encrypted just like the rest of the computer program product and can only be decrypted and read with the associated certificate.

After the preferred completion of the installation and entrance of a user name and the required password, the certificate for the new or additional installation is stored in the created folder. The registration key can only be used for the maximum number of installations. For the additional installation, the registration key and the certificate of the already-installed computer program products must always be used. Each new installation generates a new device-dependent security certificate.

The preferred method preferably operates on an IP basis, wherein it preferably uses current standards to interconnect communication devices in IP-based networks. Expressed in other words, there is preferably an IP-based connection between the first communication device and the second communication device. The preferred method therefore also includes the provision of an IP-based connection. This IP-based connection makes it possible for the first time to exchange data, voice or images (including films) via these connections, for example using SIP protocols. Just like email programs or social media platforms, the preferred method can also use GPS, 5G, WLAN, LAN and/or other methods to establish IP-based connections. The average person skilled in the art will recognize that an IP-based connection means a connection that is based on at least one Internet protocol.

The preferred method or the corresponding computer program product (Point One) does not require SIP protocols or proxy servers to establish communication. The preferred method and therefore the corresponding computer program product also does not use their protocols or certificates to verify the connections between communication devices. The preferred computer program product is preferably registered on a registration server. After registration, it is advantageously possible to conduct secure conversations in a public space (Internet) without relying on common standards such as SIP protocols or servers from service providers such as Microsoft, on which the connections are buffered or stored.

The orientation of the present aspects according to the invention departs from the approach that anyone can communicate with anyone, and instead pursues the approach that only users who have clearly identified themselves on the intermediate server and who have also agreed to make contact with a requesting communication partner in the past can make contact with each other and/or exchange data. Therefore, the preferred method concerns an identification of a communication partner on the intermediate server.

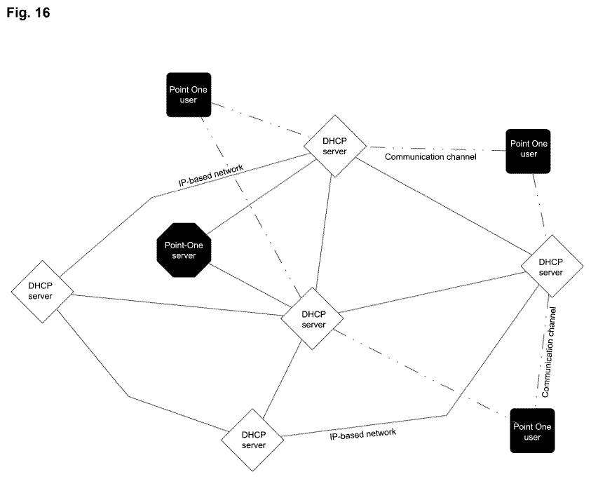

In contrast to the technologies known in the prior art, here the approach of the broadest possible use is therefore not followed, but rather the approach of a strongly limited possibility of making contact with others (FIG. 16).

The functionalities that were previously provided in the prior art, for example by the SIP protocol and/or by proxy servers, are provided directly from the computer program product in the preferred computer program product and the computer-implemented methods designed therefor. SIP protocols could meet the associated requirements because the orientation and function of the preferred computer program product differs fundamentally from the prior art.

This and the already previously negotiated communication permission and the resulting encryption, especially end-to-end encryption, make communication secure and require only an existing Internet connection. The required Internet connection advantageously requires only the standards defined by the W3C Consortium in order to establish communication.

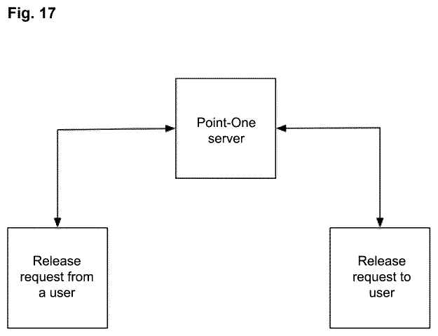

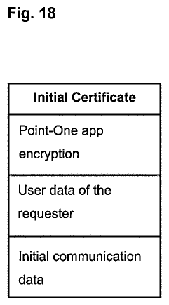

Unlike the SMIME/SSL certificate, the certificates that are used in the preferred method (the person skilled in the art will recognize that when “method” is used in the context of the invention, a preferred computer-implemented method is meant) and/or provided by the preferred computer program product do not have a public key. Preferably, an initial certificate is created when a user or communication partner logs in to the intermediate server (see FIG. 17). The initial certificate is preferably used to send an invitation to a second communication partner. The initial certificate is preferably a security certificate. Preferably, an invitation is transmitted from the first communication device to the second communication device, wherein an initial certificate is transmitted to the second communication device upon transmission of the invitation. The initial certificate comprises a key and preferably certified user data of the requester or the first communication partner and/or the first communication device (see FIG. 18). If the invitation of the requester or the first communication partner is accepted, the first communication partner or the requester will preferably receive an approval confirmation. The approval confirmation is preferably created by the intermediate server. Through the approval confirmation, the first communication partner or the requester preferably receives the release certificate, preferably from the intermediate server. Preferably, the release certificate provides the certificates required for communication and all data that are required for communication over the Internet. The aforementioned preferred steps are preferably carried out after acceptance of the invitation. If the request is rejected, it is preferable for the requester to receive information, preferably from the intermediate server, that communication is not desired. Communication would then not be possible.

With the information exchanged through the certificates, the computer program products of the first communication partner and the second communication partner are preferably automatically linked to one another, so that communication and thus an encrypted exchange of data is enabled.

Preferably, the contact data are regularly transmitted to the authorized users in the communication network of the user and to the intermediate server. These data advantageously ensure that the individual users can connect with each other at any time.

If a user or communication partner has not been in the network for a while, it is preferable for the computer program product to receive these data from the intermediate server in order to thus enable integration back into the communication network. The comparison is preferably also carried out directly between the authorized users in a network. Thus, the data of the intermediate server are preferably only required if the user the communication device on the computer program product is installed was no longer connected to the Internet.

During the preferred method and thus also through the use of the preferred computer program, the initial certificate, the release certificate and a communication certificate are used. By means of the initial certificate, in particular the release process is created. The release certificate enables acceptance into the communication network to be accepted. The communication certificate is used in particular to encrypt the communication data and preferably includes identification data and/or parameters for the available resources. Preferably, the communication certificate also includes the communication data. The initial certificate, the release certificate and the communication certificate represent security certificates in the context of the invention.

Therefore, in a further preferred embodiment, the invention relates to a computer-implemented method for information-secure communication between at least a first communication partner and a second communication partner, wherein the first communication partner has a first communication device, and the second communication partner has a second communication device, comprising the following steps:
a) installing a computer program product on a computing unit of the first communication device and the second communication device,
b) transmitting an invitation from the first communication device to the second communication device, wherein an initial certificate is transmitted to the second communication device upon transmission of the invitation,
c) accepting the invitation by the second communication device and verifying the initial certificate,
d) feeding back to an intermediate server when the initial certificate has passed the test,
e) transmitting a release certificate from the intermediate server to the first communication device,
f) exchanging a communication certificate between the first communication device and the second communication device.

Preferably, communication data are transmitted directly between the first communication device and the second communication device.

In a further preferred embodiment, the invention relates to a computer program product for information-secure communication between a first communication device and a second communication device, wherein the following steps are carried out upon running the computer program product:
a) transmitting an invitation from the first communication device to the second communication device, wherein an initial certificate is transmitted to the second communication device upon transmission of the invitation,
b) accepting the invitation by the second communication device and verifying the initial certificate,
c) feeding back to an intermediate server when the test of the initial certificate is passed,
d) transmitting a release certificate from the intermediate server to the first communication device,
e) exchanging a communication certificate between the first communication device and the second communication device.

In a further preferred embodiment, the invention relates to a communication device network for information-secure communication, comprising at least a first communication device and a second communication device, wherein the first communication device and the second communication device each comprise a computing unit and are configured to carry out the following steps after installation of a computer program product:
a) transmitting an invitation from the first communication device to the second communication device, wherein an initial certificate is transmitted to the second communication device upon transmission of the invitation,
b) accepting the invitation by the second communication device and verifying the initial certificate,
c) feeding back to an intermediate server when the test of the initial certificate is passed,
d) transmitting a release certificate from the intermediate server to the first communication device,
e) exchanging a communication certificate between the first communication device and the second communication device.

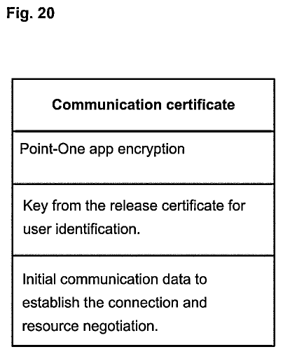

The certificates generated by the preferred method (FIG. 20) preferably do not have a public key, as is the case with SSL certificates, for example, in the prior art. Preferably, in the sense of the invention, authentication and/or creation is carried out by the preferred steps in the sense of a release process via the preferred computer program product which is installed on the computing unit of a first and second communication device. In particular, the first communication device and the second communication device are involved, i.e. the communication devices of the first communication partner and the second communication partner, or the requester and the requestee.

This advantageously ensures that data exchange is only possible between communication devices which have installed the corresponding computer program product if the release process (preferred steps comprising feeding back to an intermediate server when the test of the initial certificate has passed, transmitting a release certificate from the intermediate server to the first communication device and/or exchanging a communication certificate between the first communication device and the second communication device) has been completed via the intermediate server. Intermediate proxy servers or similar methods are advantageously not necessary since the two computer program products of the first communication device and the second communication device can establish contact directly.

The preferred method or the corresponding computer program product makes it possible to establish communication directly from communication device to communication device. Preferably, the invitation is verified in the sense of a first communication request via the intermediate server, and a communication partner and/or a communication device is clearly identified.

Furthermore, the necessary resources, such as those needed for communication in the sense of the disclosures of US 2013/0036308 A1, [1] or [2], are considerable and must be scaled with an increasing number of communication partners. The preferred computer program product advantageously uses the resources of the related communication devices themselves, in particular the communication device with which the invitation is transmitted. Only the performance of the hardware of the first and/or second communication device sets a limit for the number of communication connections to occur simultaneously.

Furthermore, the disclosures of US 2013/0036308 A1, [1] and [2] teach that different software products from different manufacturers can be developed in such a way that communication between the individual software products is possible.

The preferred computer-implemented method is designed and optimized such that communication is only possible with authorized users or communication partners who have installed the corresponding computer program product. It is designed so that each communication partner can set up his own communication network which can only be used by approved communication partners. It is therefore not possible, purely structurally, i.e. in particular due to the configuration of the computer program product, for third parties to be able to provide their own solutions for the system in order to be able to participate in the communication.

The preferred method and the corresponding computer program product are particularly suitable for users or communication partners who have a particularly high need for security. After the preferred registration on the registration server and installation, the communication partners can advantageously communicate securely and exchange data.

Currently, users with a high need for security must take additional measures to secure their communications. Additional VPN connections, SMIME certificates and/or other security technologies are now part of the basic equipment of every public authority or company. By using the preferred computer program product, additional measures to secure communication can advantageously be eliminated. This has a positive effect on the efficiency of the IT infrastructure. In addition, this is accompanied by advantageous economic efficiency, since additional costs are avoided which would be necessary for additional security measures, but which can, however, be omitted by the preferred computer program product.

In a further preferred embodiment, the computer-implemented method is characterized in that the communication data are encrypted for transmission, preferably using an asymmetric encryption method.

Preferably, the PKI method (PKI: public key infrastructure, and thus preferably a system that can issue, distribute and/or verify digital certificates) and symmetric encryption are additionally implemented in the computer program product (Point One). In addition, a unique hash which is also transmitted is preferably created for data, in particular communication data, to be transmitted, and with which the received data can be verified.

Advantageously, this makes it possible to achieve particularly high security for the communication data that are transmitted between the communication partners.

The computer program product preferably encrypts the communication data before transmission.

In a further preferred embodiment, the computer-implemented method is characterized in that a data transmission rate and/or a data capacity of communication devices of communication partners is determined.

Advantageously, by determining the data transmission rate and/or the data capacity, the computer program product can utilize capacities of the involved communication devices. In particular, the communication devices can advantageously be created in a cluster so that the resources are advantageously distributed and balanced as needed. This means that, for example, the quality in the context of a video communication depends on the communication device with the fewest resources. Since this cluster is self-contained and encrypted, third parties advantageously cannot access it.

The computer program product preferably determines, during installation, the speed at which communication data, such as video data, are decrypted and processed. This information is preferably stored and is preferably used to negotiate the video quality to be received and processed. This test can be repeated by the user if necessary, and the values can be saved again. In order for the determination of these values to lead to a result accepted by the user, the user can preferably intervene in the settings to be made and thus achieve an optimal result corresponding to the performance. To determine the existing transmission rates, generated test data are preferably sent that are similar in their nature to the communication data, e.g. the video data. In addition, these packets preferably contain a requirement profile for the optimal video data of the sender. Using the data contained in the test files, the computer program product can now preferably determine how long the data packet needed to send, and in what form the video data must be prepared for the recipient. This exchange preferably takes place for all participants in a video communication. Based on the determined performance data, an expected transmission time is preferably assigned to the individual data packets. If packets from individual users require an unexpectedly long time to be transmitted, the transmission quality for the relevant user is adjusted, in particular with the help of the preferred computer program product (or the computer-implemented method), such that an optimized transmission and easier processing are enabled. In this way, the data to be transmitted, in particular the communication data, are advantageously adapted for the recipients.

In the prior art, occasional overloads on the servers of the service providers occasionally happen since all communication runs via their servers. When using the preferred computer-implemented method and/or the preferred computer program product, the performance of the individual participating computers is preferably decisive since there is preferably no server that has to process data. According to the current state of the art, server-based solutions require not only high computing power but also the greatest possible Internet connection since many different users may, for example, hold independent video conferences at the same time.

In order to prevent impairment due to communication devices with insufficient performance, the computer program product and/or the corresponding communication device on which the computer program product is installed can advantageously be used as a relay. This means in particular that the computer program product functions as a communication server for individual participants with a weak performance and/or insufficient Internet connection. In order for the preferred computer program product to be able to function in this way, the particular communication partner must preferably activate the corresponding function in order to thereby enable a balance between the resources of the individual communication participants. Here too, the preferred computer-implemented method and thus also the preferred computer program product is superior to the current status, since data security and data sovereignty are also guaranteed in this mode, since the computer program product and/or the communication device that acts as a relay is preferably integrated as a direct participant in the communication and thus partially contributes its own data to the communication. However, these data are also preferably not saved automatically, but rather are preferably deleted after use. A participant can only save the occurring communication if all participants have preferably given their consent.

In a further preferred embodiment, the computer-implemented method is characterized in that the communication takes place between a plurality of communication partners, each of which has a communication device, and/or the communication takes place within a communication network.

Advantageously, the computer-implemented method is thus suitable both for private use and for use within a communication network. In both instances of use, an information-secure, and in particular tap-proof, communication is advantageously enabled.

In a further preferred embodiment, the computer-implemented method is characterized in that the communication takes place between communication partners, wherein the first communication device and/or the computer program product installed on the computing unit of the first communication device provides the intermediate server.

Preferably, the first communication partner acts with his first communication device as the inviter, while the second communication partner acts with his second communication partner as the invitee.

Preferably, the inviter must be reachable via a fixed IP address. Furthermore, it is preferred for the security certificates to have been exchanged beforehand so that the invitee can log in for communication, e.g. during a meeting. Advantageously, whenever an authorized user has an Internet connection with his communication device and goes online, contact information is exchanged with a computer program product of the inviter.

Preferably, the user data of the authorized communication partners are available on all approved devices. Any computer program product (Point One App) can thus preferably advantageously be used as an intermediate server.

The security certificate already described above comprises a plurality of parts, also including a public key, wherein the public key is preferably published (authenticated) on the server of the manufacturer of the computer program product.

The public key advantageously does not allow any conclusions to be drawn as to who generated this key. However, the public key is preferably used to use the information necessary to establish a connection with the invited users who have authorization for an account to establish the connection. In particular, the information required to establish the connection should be made available. The latter functionality advantageously ensures that the computer program products are accessible to each other as soon as a communication partner is online with them, even if, for example, individual devices frequently change location and/or have not been reachable for a while.

For this purpose, there is the intermediate server which enables contact to be established between communication partners, in particular for private use. The intermediate server is merely an intermediary and does not store any data other than the security certificate. According to the current state of the art, communication would be routed via the server of the software provider. In contrast, in the context of the invention it is provided that the intermediate server merely represents the point that makes the information for establishing the connection available to the authorized users.

In a communication network, the intermediate server can be installed on a separate server. Communication can thus take place within the communication network and can also be enabled with external communication partners. In this context, external communication partners preferably means communication partners who are not part of the communication network.

In a further preferred embodiment, the computer-implemented method is characterized in that the communication between communication partners takes place within a communication network, wherein the intermediate server is preferably installed on a web server and acts as an exchange.

Communication with a communication partner within a communication network is preferably established via the exchange, in particular different in particular from private use. The actual communication continues to run from communication device to communication device, but the exchange may, subject to permission, record and/or store communications. The exchange is preferably hosted by the particular communication network itself. Advantageously, no third party has access to the exchange, which enables particularly secure communication even in a communication network.

Advantageously, the functional scope of the computer program product is extended by the preferred exchange to include functions for the legally secure storage of legally relevant (e.g. business-critical) communications.

If the computer program product is preferably installed with a registration key of a communication network that the exchange uses, the computer program product can only allow contacts via the appropriate exchange. A preferred direct invitation, which can be carried out without an exchange, is then no longer possible.

In preferred embodiments, the exchange performs the following tasks:

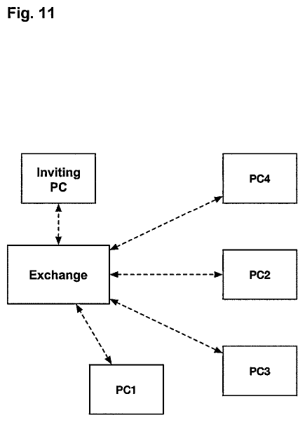

1. The exchange (see FIG. 11, 14) can only be installed once. A registration key is also required for this. This must be requested before the installation. During installation, the administrator receives an administration certificate that allows the administrator to access the exchange and administer it. If users release data for archiving and viewing, the administrator receives read and/or copy rights to this data. However, the saved data can only be read and not modified.
2. To ensure that the data remain compliant with the GDPR (General Data Protection Regulation), defined deletion and/or storage rules can be created for the data within the exchange. In order for these rules to take effect, the planned and/or completed communications must be accordingly identified by the user. Some basic provisions of the GDPR are firmly established in the exchange and are implemented automatically.
2.1. Contacts with whom no contact has been made within the last 24 months will be automatically deleted. Before deletion, the user to whom the particular contact was assigned receives information that enables him to establish contact with the user so that the automation starts again at zero (months since the last establishment of contact).
2.2. Data are backed up fully automatically. The backup cycle and type of backup are preset by the administrator.
2.3. All backed-up data records are identified by the exchange in such a way that the administrator can also delete data records within the backups. This does not apply to data that have been identified as legally relevant. These data can only be deleted once the specified retention period (in years) has expired.
3. Receipt and temporary storage of messages, even if the recipient is currently offline (not reachable). This means that incoming messages are stored until they can be transmitted to the recipient. If the data are to be stored for legal reasons and/or based on internal needs, the exchange can be configured such that the memory is retained, and the administrator can read it out if necessary. To make this possible, each affected employee must consent in that he activates this storage function via the computer program product.
4. Managing security certificates so that messages can still be read after an employee leaves. However, this requires the approval of the relevant employee. Approval is granted via a setting within the computer program product. The approval can be withdrawn only for future data. Data that are created while the approval was granted can no longer be accordingly protected by the user.
5. Storage of communication contacts of all external and internal users of the computer program product. Unlike with private users, when using the exchange, communication is not established via the computer program product, but via the exchange. Since communication via the exchange can be stored, data are generated here which can be viewed by third parties after approval by the user.
6. Forwarding communication requests to external and internal users. All contacts stored in the computer program product are managed in the exchange. Individual communication partners or groups can be blocked and/or approved (again) by the administrator via the exchange. A blocked user can no longer be contacted via the computer program product. Unlike in private use, the user cannot contact other users via the exchange without approval. This applies to both internal and external communication (in relation to the communication network).
7. The address books of the authorized users for both internal and external contacts are managed by the exchange and can be shared within the communication network. Contacts can only be shared and approved for others with their computer program product via the exchange. If external user contacts are to be approved for other internal users via the exchange, the external user must confirm the approval request before the approval can take place.
8. The exchange stores all data encrypted so that the data are protected against unauthorized accesses. To ensure that the data approved by individual users remain usable, the administrator can obtain an administration certificate via the exchange.
9. Differing from typical mailboxes, the communication data are stored on the server but do not remain in an active memory. Instead, they are archived directly. The data can only be directly accessed within the computer program product in order to work with them. If the data on the computer become corrupted or the user receives another company computer, the data can be restored from the backed-up server data. If the data have been deleted by a rule or a preset automation, they cannot be restored.
10. Depending on the type of application and the amount of data to be stored, the exchange must have sufficient resources. This applies to both the storage space and the performance of the employed server.

In the current state of the art, all communication goes through external service providers or software providers who have ultimate control over the software and data. According to the invention, this is prevented in particular by the computer program product by enabling direct communication from communication device to communication device.

In the preferred use, the exchange sets up a cluster comprising a connection of a plurality of communication devices and controls the load distribution so that peaks cannot occur on the server itself. In the current state of the art, it is always problematic when an unexpectedly large number of users accesses the server or server cluster at the same time, which often results in disruptions or communication breakdowns. Advantageously, this cannot happen with the use of the preferred computer program product or the computer-implemented method, since the burden is borne by the communication partners who are involved in the communication.

The method of load distribution preferably follows the same method as that already described in the preferred method of load distribution by the computer program product. The only difference is that the exchange acts as a relay and not the computer program product or the corresponding communications device on which the computer program product (Point One) is installed. In the context of a communication network (e.g. companies, schools), in this way various conferences with a large number of users with stable connections can advantageously be set up at the same time.

Advantageously, recordings of video conferences, for example, are not stored via the exchange. Instead, all recordings, such as audio and/or image recordings, are preferably always stored within the secure computer program product and can only be exported with the permission of the communication participants.

In terms of the invention, a communication network refers to an organization that strives to be able to carry out Internet-based communication. Communication can take place both within (internal), and with communication partners outside (external), the communication network. For example, a communication network can be selected from a group comprising a public institution, an educational institution, a treatment facility and/or a company. Preferably, the communication network represents a company.

In a further preferred embodiment, the computer-implemented method is characterized in that the communication data are selected from a group comprising text messages, photos, videos, audio messages and/or attachments.

Advantageously, different types of communication data can thus be transmitted. There is therefore no restriction to a specific type of communication data.

The current state of the art when sending emails is highly insecure. Email addresses can be stolen, faked and/or disguised, so that the recipient often cannot tell who the real sender is. Messages such as emails sent via the preferred computer program product are always clearly ascribable to the sender. The exchanged certificates as well as the unique registration advantageously prevent third parties from carrying out unauthorized sending of messages to a recipient.

With the current state of email technology, it is possible, for example, to write to any person with an email account. The preferred computer-implemented method using the preferred computer program product enables persons to send, for example, a message to another person only if this person has previously been approved as a sender by an accepted invitation.

Furthermore, in the current state of the art, attachments such as documents can be attached, in particular to emails and/or by other transmission channels. However, without additionally undertaken security measures, these are often transmitted unencrypted and can therefore be read by third parties. Advantageously, the preferred computer program product enables attachments (such as documents) to be attached to messages. Advantageously, these are then transmitted just as encrypted as the rest of the message. In addition, the user can assign rights to documents so that he can specify what the recipient can do with the received documents.

In a further aspect, the invention relates to a communication device network for information-secure communication, comprising at least a first communication device and a second communication device, wherein the first communication device and the second communication device each comprise a computing unit and are configured to carry out the following steps after installation of a computer program product:
a) transmitting an invitation from the first communication device to the second communication device, wherein a security certificate is transmitted to the second communication device upon transmission of the invitation,
b) accepting the invitation by the second communication partner and verifying the security certificate,
c) feeding back to an intermediate server when the test of the security certificate has passed,
d) directly transmitting communication data between the first communication device and the second communication device.

The preferred computer network advantageously leads to secure, in particular tap-proof communication between communication partners. In this case, communication data can advantageously be transmitted directly mutually between the communication devices of the communication partners. Advantageously, the connection between the individual communication devices is not established via a server, but is established directly between them. In particular, the connection between the communication devices is advantageously encrypted.

A communication device network preferably refers to a network comprising a network comprising a plurality of communication devices for the purpose of exchanging data. The communication device network therefore creates the possibility of carrying out the exchange of data between the communication devices.

The communication device network can preferably be used for private use, in particular by the computer program product.

Therefore, in a further preferred embodiment, the communication device network is characterized in that the communication takes place between communication partners, wherein the computing unit of the first communication device and/or the computer program product installed on the computing unit of the first communication device is configured to provide the intermediate server.

Since, in contrast to the embodiment of a communication network, there is no exchange, it is preferred that the first communication device, which acts as an inviter, has a fixed IP address. Consequently, the second communication device (invitee) can log in for communication so that direct transmission of communication data between the communication devices is enabled. It is preferred that as soon as a user goes online with his communication device, contact information is exchanged between the first communication device and the second communication device.

It is also preferred that the communication device network exists in the context of a communication network. Accordingly, in a further preferred embodiment, the communication device network is characterized in that the communication between communication partners takes place within a communication network, wherein the intermediate server is preferably installed on a web server and functions as an exchange.

Preferably, after the installation of the intermediate server on a web server of the communication network, all communication partners who use the computer program product are created as users in the exchange. Preferably, authorizations for future communications are stored via the exchange. Furthermore, it is preferred that the exchange stores contact information, such as the email address of the authorized and blocked communication partners. Particularly preferably, the email address is the relevant information about the communication partners in the context of a communication network.

The preferred invitation establishes the communication with the exchange and passes on the information required to establish the connection to the particular computer program product. Thus, in the future, the exchange will preferably pass the required information to the particular computer program product upon request from the computer program product. This advantageously allows the communication devices to connect directly to each other.

If, in preferred embodiments, the invitation is deleted on the exchange, no data will be exchanged with the blocked or restricted user in the future.

Preferably, the user (e.g. an employee of the communication network) and a one-time password are exchanged for the initial setup with the exchange. The transmission of the communication data is preferably encrypted. Accordingly, it is preferred that all information required to establish the connection is stored within the computer program product.

In a further aspect, the invention relates to a computer program product for information-secure communication between a first communication device and a second communication device, wherein the following steps are carried out when executing the computer program product:
a) transmitting an invitation from the first communication device to the second communication device, wherein a security certificate is transmitted to the second communication device upon transmission of the invitation,
b) accepting the invitation by the second communication partner and verifying the security certificate,
c) feeding back to an intermediate server when the test of the security certificate has passed,
d) directly transmitting communication data between the first communication device and the second communication device.

Advantageously, the use of the preferred computer program product leads to tap-proof communication of the communication data. In particular, the communication data are advantageously not sent to the server of the manufacturer of the computer program product. Instead, a direct, correspondingly serverless exchange of communication data advantageously takes place.

The preferred computer program is preferably available in two preferred embodiments. In one preferred embodiment, the computer program product is configured such that invitations can be sent and received. In a further preferred embodiment, the computer program product is configured such that invitations can be accepted but not sent.

In a further preferred embodiment, the computer program product is characterized in that the computer program product provides a user interface so that the invitation can be sent and/or accepted by operating the user interface.

The computer program product thus comprises a network layer, a functional layer and a database. In particular, the network layer includes the function of sending out invitations. The functional layer allows communication data to be transmitted and optimized (relay layer) so that chat, video, audio and/or general data exchange is enabled. The database preferably contains information regarding transmitted communication data, e.g. chats, as well as information about communication participants and information about deleted communication participants. In particular, by using the providable user interface, it is possible to send invitations in order to be able to communicate. It is also possible to accept invitations.

The preferred computer program product preferably has a user interface (GUI, graphical user interface) with which the individual functions can be controlled. Advantageously, it is not possible to control the computer program product from outside. The individual functions are optimized to ensure the highest level of security for their users. Advantageously, there are no automations that can be used to automate processes such as sending messages or chats.

Bulk sending of messages is also not possible. The computer program product is not intended to reach masses of participants at once. Rather, everything is advantageously subordinated to the aspect of security and coordinated and structured communication.

In a further preferred embodiment, the computer program product is characterized in that the computer program product provides a user interface so that the invitation can be accepted by operating the user interface.

Thus, there is also an embodiment that only comprises a functional layer and a database. This allows invitations to be accepted but not sent.

The average person skilled in the art will recognize that technical features, definitions and advantages of preferred embodiments, which apply to the computer-implemented method according to the invention, apply equally to the communication device network according to the invention as well as to the computer program product according to the invention, and vice versa.

Furthermore, the average person skilled in the art will preferably recognize that steps, such as method steps, and/or capabilities of the aspects of the invention can preferably also be directed to the preferred computer program product comprising instructions that can effect corresponding steps, such as corresponding method steps, and/or corresponding capabilities.

The following explanations preferably apply to the aspects according to the invention, in particular to the computer program product, the computer-implemented method and the communication device network

In order to make communication not only secure via the Internet, but also to manage it securely on the computer and to protect the stored data or ongoing communication against access by malware that is already running on the host system's operating system, the software (computer program product) must be shielded from the operating system or take over its functionality.

The invention, in particular the computer program product is a separate operating system that contains all the functions required for secure communication recording and data management.

The following conditions must be met to ensure security:

1. There is one installation per user and access to the installed software is protected. Protection can be provided via a password or other secure authentication. This means that there is only one user at a time who can access the stored data or communication information.
2. The screen display must not be able to be recorded by third-party programs. This means that it is impossible to take a screenshot.
3. Processor, memory and cache are encrypted and shielded against access by third-party software. The invention, in particular the computer program product, is therefore shielded against the installed operating system, software installed by the user and malware that works unnoticed.
4. At the same time, the invention, in particular the computer program product, must also be able to use all the components required to establish a connection, to display the desired information on the monitor or to print it out.
5. The invention, in particular the computer program product, can be operated on the existing hardware with the operating system installed. Additional hardware is not required.
6. The hardware must fulfill certain performance-related requirements.
Example minimum requirements: 16 GB RAM, 17/M1 processor, 1 Gb network card, 40 GB SSD space for installation

### Procedure:

1. The invention, in particular the computer program product, is installed in a kind of encapsulated (encrypted) container.
2. The invention, in particular the computer program product, detects the relevant hardware components during installation and retrieves the corresponding required drivers from the driver database provided.
3. After starting the invention, in particular the computer program product, it works like a virtual operating system that is completely independent and shielded from the actual operating system.
4. All data created within the invention, in particular the computer program product, (messages, texts, images or videos) are stored within the container.
5 During installation, an exchange folder is created via which data can be imported or exported to the container.
6. All data to be imported is checked on the basis of defined security guidelines before import and can only be imported after the check has been passed.
7. To protect the data, all stored information can be exported in encrypted form. The data can only be decrypted again with the password specified during export and a functioning installation of the invention, in particular the computer program product. The encryption is an asymmetric procedure.
8. In contrast to communication encryption, the installation on the computer is encrypted symmetrically. The algorithm for creating the key is structured in such a way that the installation (the virtualized environment) only works on the computer on which it was originally installed (for the first time). This means that an installation cannot be transferred to another computer in order to be operated there.
9 The following operating systems are supported (preferably):
Computer: Windows 11 and newer MAC OS 15 or newer, Ubuntu 22 and newer

Mobile: Apple IOS 18 and newer, Apple IPad OS 18 and newer

### Programming:

1. The invention, in particular the computer program product, has a high security requirement and must work efficiently to a high degree. To ensure this, we use preferably “C” as the programming language.
2. Since the kernel replaces the operating system, object-oriented languages do not make sense because their libraries were not developed for the used core system in the context of the invention.
3. Prefabricated program elements are not used in order to keep the source code as small and secure as possible.
4. The individual elements are arranged modularly around a micro kernel. This approach was chosen in order to minimize the need to make changes to the system kernel in the event of adaptations, further developments or updates. Ideally, the kernel should only rarely need to be adapted.
5 The kernel is responsible for basic communication with the hardware and for encrypting the data.
6. Modules are program parts that are responsible, for example, for video communication, chats, language settings, data exchange or the creation of data. A module is also responsible for checking the data to be imported.
7 This approach ensures security as well as expandability and enables the use of different development teams without having to disclose fundamental elements of the kernel.
8. The kernel or interfaces to the kernel are only adapted if vulnerabilities are discovered or if changes to the hardware architecture require this. These adaptations then lead to a new version that has to be reinstalled.

The concepts according to the invention are explained in more detail below on the basis of examples, without being limited to these examples.

### DETAILED DESCRIPTION OF THE FIGURES

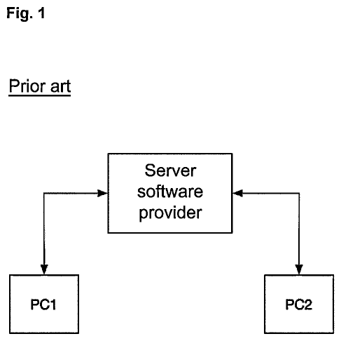

FIG. 1 shows a method for communication which is used in the prior art.

Here, PC1 sends a message to PC2, which is forwarded to the software provider and from there to PC2. The server of the software provider therefore receives all messages and can read or process them.

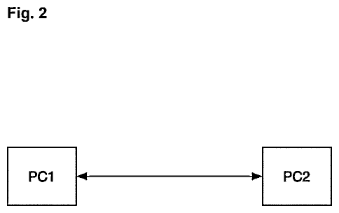

FIG. 2 shows a preferred method of communication.

The communication between the two PCs is established directly and encrypted; the data are not buffered by any server. The communication is encrypted and transmitted directly between the two PCs via the computer program product according to the invention (Point One App).

FIG. 3 shows a data exchange between an intermediate server and a communication device.

The user begins the installation of the computer program product; after entering the registration key, communication with the registration server is established. After the server has accepted the registration key, a security certificate is created on PC 1.

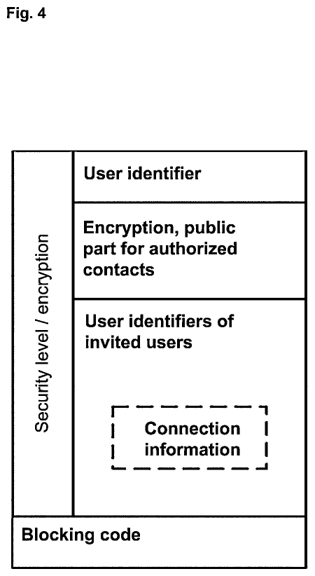

FIG. 4 shows the structure of the security certificate.

After successful registration, the computer program creates a security certificate. The public part of the certificate contains the data for establishing communication. The communication information includes a unique user identifier.

The user identifier is assigned to the computer program product and not to the person. It therefore cannot be determined which user belongs to which identifier. This security certificate is renewed at regular intervals and contains the current information by means of which the communication device can be addressed.

The communication information includes the user identifiers that were invited by the user of the communication device. When a contact is added, the security certificate on the intermediate server is immediately updated with the additional new contact information. These data also cannot be assigned to any person. The same thing happens if the location or IP of the user changes. All this information is encrypted and does not allow any conclusions to be drawn about the user or his location.

It only determines which user identifiers match so that they can exchange the particular information and thus communicate with each other.

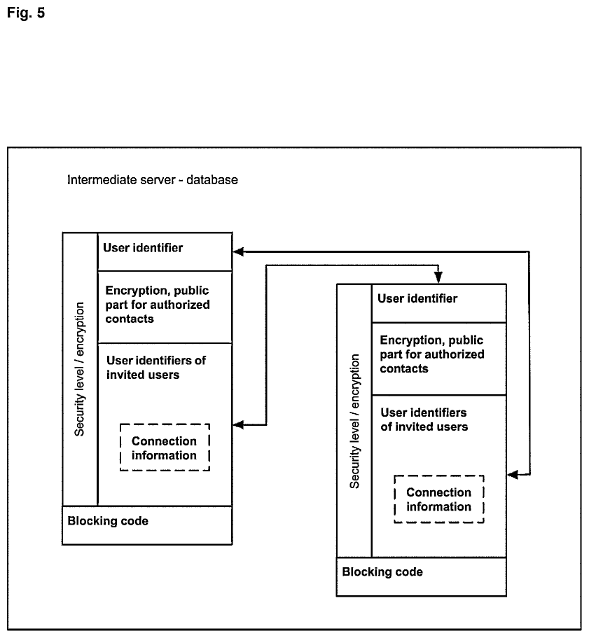

FIG. 5 shows certificate-based connection controlling.

The user identifier of the inviter and the user identifier of the invited communication partners are compared in order to verify authorized connections between individual users. Only if the certificate stored on the intermediate server contains the user identifier of an authorized user will the two certificates be linked. Whenever an invitation is accepted, the certificates are updated. This also applies if a user is removed from the contacts. This means that if the user identifier of the removed contact is deleted from the security certificate, the local change of the certificate starts an update process that transmits the changed certificate to the intermediate server and thus prevents future exchange of connection data with the former contact.

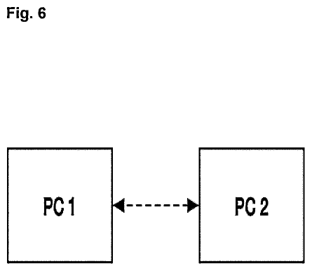

FIG. 6 is intended to illustrate how data exchange takes place without an intermediate server.

If the intermediate server (one of several) cannot be reached, the computer program products independently make contact with other computer program products with which contact information has already been exchanged, and thus directly exchange the most up-to-date connection information. Before the exchange takes place, it is checked whether the user identifier has already been accepted on both sides. Only if the user identifiers are present within the security certificates will the connection be established and the information exchanged.

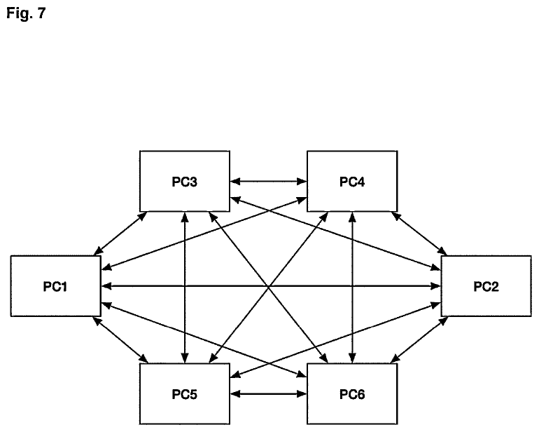

FIG. 7 describes the behavior of clients as soon as the intermediate server can no longer be reached.

In the current state of the art, it is no longer possible to communicate via the usual Internet channels as soon as the communication server (e.g. Office 365, Teams, Zoom, Skype, etc.) fails. According to the invention, the possibility of communication is maintained despite failure of the server, because the clients initiate the direct exchange of connection information.

Even if individual PCs were offline at the time of the intermediate server failure, they are gradually reconnected to the network as soon as they come back online. Since the PCs re-establish contact with each confirmed contact, the network is rebuilt.

It is therefore sufficient if one user of a contact network is reachable at the time of the failure. Through this one user, it is possible for other users to gradually reconnect to the network. With each additional connected user, the speed at which the network is rebuilt increases exponentially.

The difference between the exchange and the intermediate server lies primarily in the following points:

You can preferably register as a new user via the intermediate server, and the exchange must also register for installation on the intermediate server. However, the intermediate server preferably does not store communication data and cannot be used as a relay. The intermediate server preferably only manages the registration and certificate data and preferably provides the connection data.

The more contacts an individual user has authorized, the faster this user can be integrated back into the network. New contacts or new installations of computer program products are not possible during a failure of the communication server.

The same conditions apply to companies that use the exchange. These clients can also continue to communicate with each other. The differences lie in the expanded functions of the exchange. As long as it is offline, it cannot store any data, and any ongoing communication can only be tracked via the computer program on a computer.

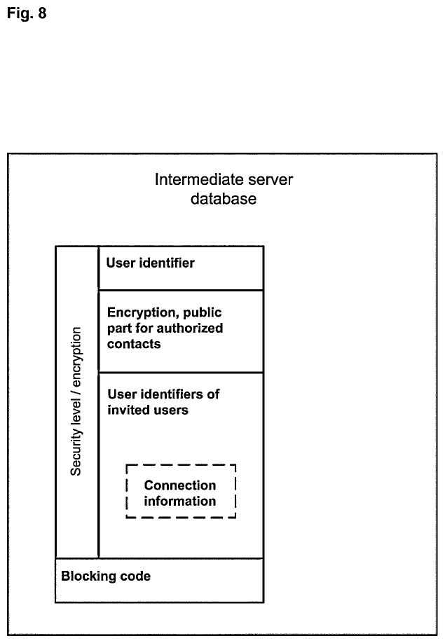

FIG. 8 shows a method for the intermediate server or an application for registering certificate-based invitation of additional anonymous users.

Each security certificate is encrypted and has a security level that is generated upon the creation of the certificate. The intermediate server checks the certificates for correctness and for tampering. If this check reveals unauthorized access or the certificate displays an error, it is rejected, and the sender of the security certificate is blocked.

Since the user identifier does not allow any conclusions to be drawn about the person to whom this identifier is assigned, the affected user must first prove that there was no misuse, but that there was a technical problem for the certificate rejection.

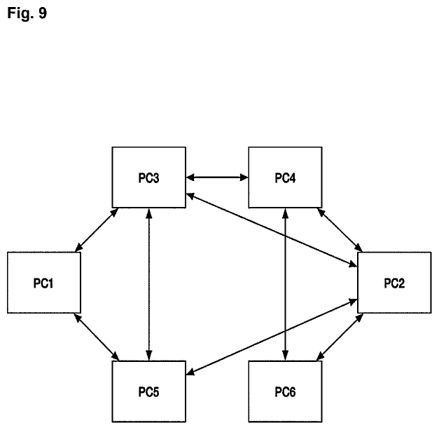

FIG. 9 shows a load distribution with regard to data exchange.

During the communication setup, the computer program product determines the available Internet bandwidth and the available computer capacities. The computers participating in the communication then negotiate how the loads of the data exchange are to be distributed.

In addition to reducing the loads on weaker devices or devices with a weaker Internet connection, this also reduces the total amount of data to be transferred. For companies that use an exchange, communication can also be completely distributed and controlled thereby.

The negotiation of resource distribution takes place via the inviting computer. Since all invited users dial into the communication via this computer, it is also responsible for distributing the data streams.

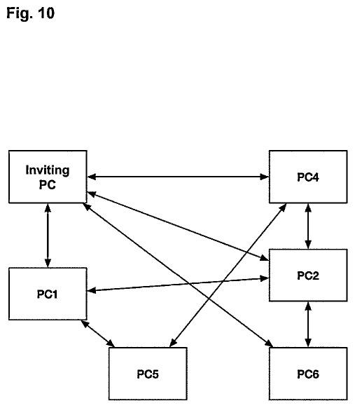

FIG. 10 shows a load distribution.

The inviting computer receives the information about available resources. At the same time, it informs the connected computers as to which computers are still involved in the communication and forwards the connection information to all participants in the meeting. These data are only stored temporarily and are used to determine the connection speed and reachability of the individual computers involved in the communication. In this way, the most efficient connection routes between the participants are ascertained and established.

The connection routes and load distribution are negotiated between the computers using the following rules or the following method:

### 1. The Communication Profile is Automatically Sent to Each Participant

The profile transmits the previously determined data regarding the computer performance as well as a timestamp to determine the transmission quality, the desired type of communication and the expected resource requirements. The communication profile preferably refers to a summary of the information on the processing speed, e.g. of video data, the determined Internet speed downstream and upstream, and/or the time stamp with the start of the data transmission, in particular of communication data.

### 2. Determination of Current Resources

The computers determine their own available resources and send the result to the inviter and to all participants.

### 3. Determination of Communication Channels

In parallel, the computers determine the connection speed to each participant and to the inviter.

### 4. Creating the Configuration File

Based on the incoming information, the inviting computer determines which quality level is possible on the computer with the fewest resources, creates the settings file and sends it to all participants. In this settings file, it is also determined how the computers are connected to each other. This also makes it possible to split data packets and thus avoid peak loads. The individual computers constantly report the connection quality to the inviting PC. This makes the connection optimization process a dynamic process that runs continuously in the background.

FIG. 11 shows a load distribution with an exchange.

For companies that use an exchange, the exchange can be used as a center for coordination and ongoing optimization processes. The inviting PC, if its computer program product is coupled to an exchange, can specify that the exchange negotiate the settings file with the participants and control the ongoing optimization process for the meeting.

The communication itself continues to take place directly between the individual computers.

FIG. 12 shows a preferred encryption.

The computer program product contains all elements for independently establishing an encrypted communication. The user who wants to invite another user sends a certificate with the email address to the intermediate server of a user he wants to invite.

The intermediate server uses the email address to check whether this user is already registered. The email address is also in encrypted form within the certificate and cannot be read in plain text.

If the email address is already registered, the intermediate server forwards this invitation to the corresponding user in the form of an invitation certificate. If this user accepts the invitation, a corresponding certificate is sent to the intermediate server, and both users are linked to each other via their user certificates. The inviter is then informed via the intermediate server about the fact that the invitation has been accepted.

If the invitation is declined, the inviter will also be informed about the fact that the invitation has been rejected. In the event of rejection, however, there is no linkage of the certificates.

If the email address is not yet certified, the inviter will be informed that the invitee is not yet using the computer program product.

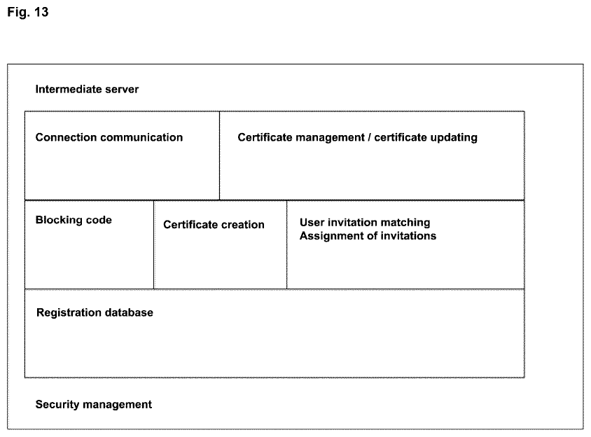

FIG. 13 schematically shows the functional principle of the intermediate server.

The intermediate server is used to register new users and to compare user invitations. To protect against misuse, each user must clearly identify themselves in order to be able to register. Registration for the computer program product is the only point at which the user can be clearly identified.

The registration key that is required for installation is generated during registration. At the same time, a sequence is created within the registration key that can be used to block the person in question. This code sequence becomes part of the security certificate after logging in to the intermediate server. Since the security certificate is encrypted, the sequence required to block individual users and the existing blocking code cannot be directly assigned to the user.

The intermediate server preferably comprises a plurality of levels or layers:

### 1. Security Management

The intermediate server only accepts registration requests (registration certificates), user certificates or invitation requests (invitation certificates) for communication. Each certificate is checked for authenticity and accuracy before processing. If the check cannot be completed successfully, acceptance/processing will be refused.

### 2. Registration Database

Only when the security administration has approved the incoming certificate can it be processed by the registration database. If processing ends with a negative result, a blocking code is created that prevents final installation/startup. However, if a positive result is generated during registration, a security certificate is created with which the user is registered on the server. The user certificate is then sent to the applicant, and the computer program product (Point One App) can be used.

### 3. Blocking Code

The blocking code is always created. If the registration is successful, it will be stored in the database and will remain saved there. In the event of misuse, a user can thus be specifically blocked without anyone having to know which security certificate was assigned to the user. This allows users to be blocked even if the security certificates cannot be assigned to the users.

This is a passive blocking. This means that the user is not excluded from the account; rather, only the blocking code is activated in the security management, and thereby any further communication with the intermediate server is prevented. At the same time, the computer program product is blocked on all of the devices of the user via the feedback of the unauthorized certificate. As a result, the communication device also stops communicating with all authorized invited users or all accepted invitations from other users.

### 4. Certificate Creation

The user certificate is created during registration and enables the final setup of the computer program product. This certificate is used when setting up the computer program product and is expanded with security features of the computer and expanded encryption. The actual security certificate is sent to the transmitted server address and the now-integrated registration data after the completion of the installation on the PC.

### 5. User and Invitation Matching

Once a user has successfully registered, his email address is stored in the user database. If a user now invites another user, the invited user is informed of this via the registration server. This information is transmitted to the user via the registration certificate. If said user accepts the invitation, the security certificate in the computer program product is supplemented with this information and then updated on the registration server.

### 6. Certificate Management

The invitation matching now creates the connection between the certificates of the particular users. For this purpose, the part of the certificate that manages the invited users is used, and in certificate management, the certificate of the inviter is provided with an addition that confirms the acceptance of the invitation. Directly afterward, this certificate is sent to the inviter. If said inviter now confirms this on his computer, the certificate within the computer program product is supplemented to include the information of the invitee. From this point on, the inviter and the invitee can communicate with each other via the computer program product.

### 7. Connection Communication

Here, the connected computer program products (Point One Apps) publish their communication data via their security certificate. Computer program products that have the appropriate identifiers can retrieve the corresponding certificates in order to communicate with other users. If the intermediate server cannot be reached, the individual computer program products begin to compare this data via their already integrated contacts.

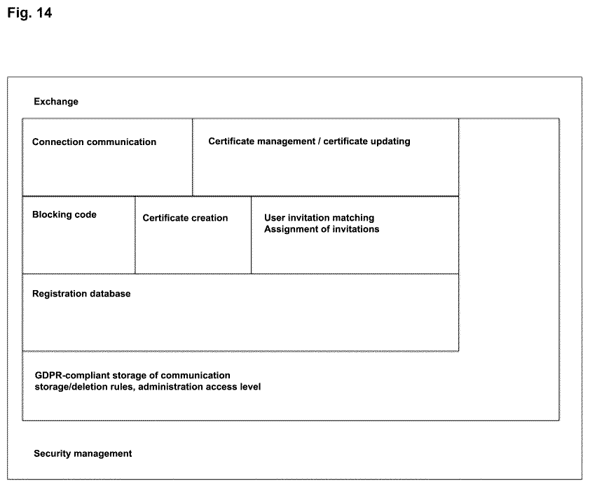

FIG. 14 serves to illustrate the exchange.

The exchange for a communication network, in particular for companies, replaces the intermediate server and takes over its tasks. The exchange has an extended range of functions for storing communication data and functions that ensure this storage in accordance with data protection requirements (GDPR).

The exchange itself is preferably registered via the company's own domain. A blocking code is also created upon registering the exchange so that it can also be blocked. If the exchange is blocked, all computer program products registered with it will also be blocked at the same time. Since computer program products can only be registered with the intermediate server or with the exchange (for companies), further use of the computer program product is generally no longer possible after the blocking of the exchange. Since it is not possible to register more than one installation on a computer, a company computer that is connected to a blocked company account can no longer be used with the computer program product. If this is nevertheless necessary, the company registration (of the blocked account) must first be deleted from the intermediate server. If a computer is sold, its registration must be removed from the exchange so that a corresponding computer program product can be reinstalled on it.

In contrast to private use, the company assigned to the registration certificate can be seen in plain text on the exchange. Since this is the only moment in which the exchange exchanges data with the computer program product intermediate server, data security and data sovereignty are also guaranteed for companies. Only the area in the exchange provided for blocking can still be reached by the intermediate server of a computer program product after registration.

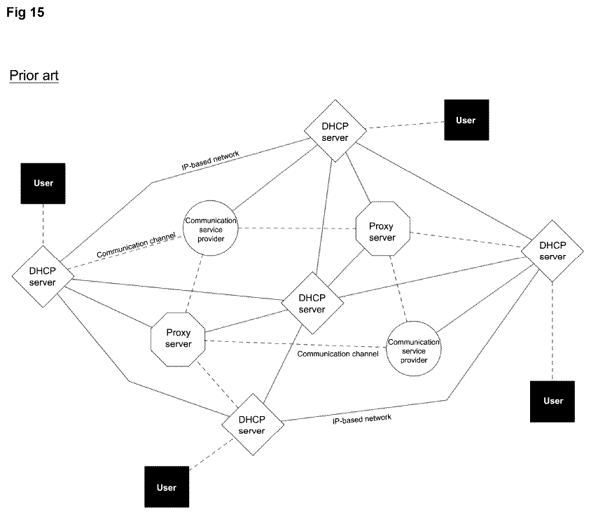

FIG. 15 schematically shows the usual communication through the Internet known from the prior art.

In the prior art, it is common for the provider to monitor the functioning and controlling of communication. For example, the SIP protocols control, regulate and monitor the communication running with them.

Among other things, this leads to manufacturers of hardware and software making ever greater efforts to prove that communication via their products is secure. However, as soon as the interests of the producers diverge from those of the users, security can no longer be fully guaranteed.

Given the large number of service providers whose technologies are used for communication, communication security can only be ensured through massive additional measures on the part of users.

FIG. 16 schematically shows an IP-based communication preferred in the context of the invention.

The method, within the meaning of the context of the invention, uses an IP-based network to establish connections between communication devices.

Using the data of the approved communication partners, which are stored in the computer program product and regularly updated, users can communicate directly with each other.

Apart from the servers required for network operation (registration servers and intermediate servers), no additional service providers or their software are required. The communication can be encrypted so that no one else can view the data. This provides a level of security that cannot be achieved using means of the state of the art.

FIG. 17 serves to illustrate a release process which can be carried out in preferred embodiments of the invention.

At the request of a first communication partner or following an invitation from a first communication partner, the requested user, i.e. a second communication partner, can accept or reject the invitation of the communication partner. The computer program product has a corresponding configuration and/or corresponding instructions for this purpose.

Using the computer program product, it is advantageously not possible to simply write a message to a random recipient. The users of the computer program product according to the invention can only communicate within their network (authorized communication partners). Each communication is provided with its own key which is valid between each of the two communication partners.

FIG. 18 schematically illustrates a preferred embodiment of an initial certificate.

In addition to the communication request, the initial certificate also contains the communication data in the sense of the user data of the requesting user (first communication partner or first communication device). Said data are stored in the computer program product by accepting the communication request, and are regularly updated.

If the communication approval is withdrawn by one of the users, the security certificates, the communication data and the user identifier of the blocked user, as well as the user data of the user who withdrew the approval, will be removed from both users.

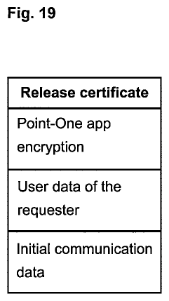

FIG. 19 serves to schematically illustrate a preferred embodiment of a release certificate.

The release certificate is sent to the requesting user (first communication partner) after the approval of requester (second communication partner).

This certificate is sent directly to the requester (first communication partner or first communication device). In this way, the two communication devices newly connected with each other now generate the certificate on the basis of which not only the encryption but also the data for establishing contact are exchanged. The certificate generated in this way can only be used by the two users of this registration process. No one else can use this certificate.

FIG. 20 schematically shows a preferred embodiment of a communication certificate.

The communication certificate encrypts the transmissions with end-to-end encryption and contains the information necessary for the setup.

Since the communication certificate always enables communication only between two users (inviter and invitee), communication with a plurality of users is only possible if each user has completed the release process (invitation process) with all participants in the communication.

### BIBLIOGRAPHY

[1] ROSENBERG J ET AL: “SIP: Session Initiation Protocol,” Request for Comments: Network Working Group June 2002, Internet Engineering Task Force (IETF) Internet Society (ISOC) 4, rue des Falaises CH-1205 Geneva, Switzerland, RFC 3261, 1 Jun. 2002 (2002-06-01), pages 1-269, XPO1 5009039.

[2] “3rd Generation Partnership Project; Technical Specification Group, Services and System Aspects; IP Multimedia Subsystem (IMS); Stage 2 (Release 17),” 3GPP STANDARD; 3GPP TS 23.228, 3RD GENERATION PARTNERSHIP PROJECT (3GPP), V17.3.0 23 Dec. 2021 (2021-12-23), pages 1-354, XP052083247.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A computer-implemented method for information-secure communication between at least a first communication partner and a second communication partner, wherein the first communication partner has a first communication device, and the second communication partner has a second communication device, comprising the following steps:
a) installing a computer program product on a computing unit of the first communication device and the second communication device, wherein the computer program product,
b) transmitting an invitation from the first communication device to the second communication device, wherein a security certificate is transmitted to the second communication device upon transmission of the invitation,
c) accepting the invitation by the second communication device and verifying the security certificate,
d) feeding back to an intermediate server when the test of the security certificate has passed,
e) directly transmitting communication data between the first communication device and the second communication device.

2. The computer-implemented method according to claim 1, wherein the security certificate is provided by the installation of the computer program product.

3. The computer-implemented method according to claim 1, wherein the communication data are encrypted for transmission, preferably by an asymmetric encryption method.

4. The computer-implemented method according to claim 1, wherein a data transfer rate and/or data capacities of communication devices of communication partners can be determined.

5. The computer-implemented method according to claim 1, wherein the communication takes place between a plurality of communication partners, each of which has a communication device, and/or the communication takes place within a communication network.

6. The computer-implemented method according to claim 1, wherein the communication takes place between communication partners, wherein the first communication device and/or the computer program product installed on the computing unit of the first communication device provides the intermediate server.

7. The computer-implemented method according to claim 1, wherein the communication between communication partners takes place within a communication network.

8. The computer-implemented method according to claim 7, wherein the communication takes place with an intermediate server installed on a web server and acts as an exchange between the communication partners.

9. The computer-implemented method according to claim 1, wherein the communication data are selected from a group consisting of text messages, photos, videos, audio messages, attachments, and combinations thereof.

10. A communication device network for information-secure communication, comprising at least a first communication device and a second communication device, wherein the first communication device and the second communication device each comprise a computing unit and are configured to carry out the following steps after installation of a computer program product:
a) transmitting an invitation from the first communication device to the second communication device, wherein a security certificate is transmitted to the second communication device upon transmission of the invitation,
b) accepting the invitation by the second communication partner and verifying the security certificate,
c) feeding back to an intermediate server when the test of the security certificate has passed,
d) directly transmitting communication data between the first communication device and the second communication device.

11. The communication device network according to claim 10, wherein the communication takes place between communication partners, wherein the computing unit of the first communication device and/or the computer program product installed on the computing unit of the first communication device is configured to provide the intermediate server.

12. The communication device network according to claim 10, wherein the communication between communication partners takes place within a communication network.

13. The communication device network according to claim 12, wherein the communication takes place with an intermediate server installed on a web server and acts as an exchange between the communication partners.

14. A computer program product for information-secure communication between a first communication device and a second communication device, wherein the following steps are carried out upon execution of the computer program product:
a) transmitting an invitation from the first communication device to the second communication device, wherein a security certificate is transmitted to the second communication device upon transmission of the invitation,
b) accepting the invitation by the second communication partner and verifying the security certificate,
c) feeding back to an intermediate server when the test of the security certificate has passed,
d) directly transmitting communication data between the first communication device and the second communication device.

15. The computer program product according to the claim 14, wherein the computer program product provides a user interface so that the invitation can be sent and/or accepted by operating the user interface.

16. The computer program product according to claim 14, wherein the computer program product provides a user interface so that the invitation can be accepted by operating the user interface.
